(19) United States
(12) Patent Application Publication
(10) Pub. No.: US 2014/0374518 A1
(43) Pub. Date: Dec. 25, 2014

(54) Compact Seed Sampling Device

(71) Applicants: LIMAGRAIN EUROPE S.A., Verneuil L'etang (FR); KWS SAAT AG, Einbeck (DE)

(72) Inventor: Jialiang Chen, Lebanon, IN (US)

(21) Appl. No.: 14/371,903

(22) PCT Filed: Jan. 14, 2013
(86) PCT No.: PCT/EP13/50599

§ 371 Date: Jul. 11, 2014

Related U.S. Application Data
(60) Provisional application No. 61/586,409, filed on Jan. 13, 2012.
(60) Provisional application No. 61/595,439, filed on Feb. 6, 2012.

(51) Int. Cl. B02C 23/08; B02C 1/02

(52) U.S. Cl. CPC B02C 23/08; B02C 1/02
USPC 241/24.1; 241/79

(57) ABSTRACT

Devices, systems and methods for crushing and extracting a portion of a seed are disclosed herein. A seed sampling device can include a crushing head having a plurality of pins and a plate having a plurality of receptacles configured to receive and contain a seed therein. The receptacles each include an aperture configured to receive at least a portion of the pins of the crushing head. A press is operably coupled to the crushing head and is configured to move the plurality of pins of the crushing head into the apertures of the plurality of receptacles and sufficiently crush the individual seeds disposed in each of the receptacles such that a portion of the crushed seeds can be communicated through the aperture and out of the plate.

### CROSS REFERENCE TO RELATED APPLICATIONS

This application claims priority to and the benefit of U.S. Provisional Application No. 61/586,409, filed Jan. 13, 2012, and U.S. Provisional Application No. 61/595,439, filed Feb. 6, 2012, the disclosures of each of which are hereby incorporated by reference in their entirety.

### BACKGROUND

Embodiments described herein relate generally to devices and systems for crushing seeds to obtain seed samples that can be used to extract DNA or other biomolecules in a fast and automated manner.

In the agricultural sciences, genetically modified crops are gaining rapid popularity. Using genetic engineering, plant cultivars can be produced that have favorable agronomical, horticultural, or economical characteristics. For example, genetic engineering can be used to produce plant cultivars that are resistant to pests and diseases, cultivars that have faster reproduction cycles, or cultivars that can be cultivated in geographical locations where weather conditions previously prevented cultivation of the species. Therefore, genetically modified crops have the potential of solving food shortage problems, particularly in impoverished locations throughout the world.

Production of genetically modified crops requires identification of a plant gene sequence associated with a favorable characteristic that can be used to modify another plant species to create a favorable crop. The testing of plant tissue, such as gene sequencing or fingerprinting requires extraction of metabolites and other biomolecules from soft tissue such as, for example, from the leaves, or hard tissue such as from seed. When double haploid technology is used for fingerprinting, genomic selection, and genetically modified organism testing, single seeds are mainly used for testing purposes. Extraction of a sample from individual seeds involves application of significant force on a seed, which can be cumbersome and result in injuries. Also, to reduce testing time and increase throughput, a large number of seed samples need to be analyzed. For example, a molecular research lab exploring genetically modified crops can produce millions of data points annually. Currently, the seed crushing stage represents a significant bottle neck to throughput as seed samples are usually extracted manually and sequentially. Thus there is a need for new seed sampling technologies that can extract samples from a large batch of seeds simultaneously and in a safe automated fashion.

### SUMMARY

Devices, systems and methods for crushing and extracting a portion of a seed are disclosed herein. In some embodiments, a seed sampling device can include a crushing head having a plurality of pins and a plate having a plurality of receptacles configured to receive and contain a seed therein. The receptacles each include an aperture configured to receive at least a portion of the pins of the crushing head. The seed sampling device further includes a press operably coupled to the crushing head and configured to move the crushing head between a first configuration such that the plurality of pins are outside of the plurality of receptacles, and a second configuration such that the plurality of pins are disposed in the apertures of the plurality of receptacles. The movement from the first configuration to the second configuration is operative to sufficiently crush the individual seeds disposed in each of the receptacles such that a portion of the crushed seeds can be communicated through the aperture and out of the plate. In some embodiments, the device can take more than one seed per well. For example, two, three, four or more seeds (e.g., kernels) can be sampled in a well at a time. In some embodiments, the number of seeds that can be sampled in a well is limited by the depth and/or the diameter of the well.

### BRIEF DESCRIPTION OF THE DRAWINGS

FIG. 1 is a schematic illustration of a seed sampling device, according to an embodiment.

FIG. 2 is a photograph of a seed sampling device, according to an embodiment.

FIG. 3 is a top view of a crushing plate included in the seed sampling device of FIG. 2.

FIG. 4 is a cross-section of the crushing plate of FIG. 3 taken along the line 4-4.

FIG. 5 is a side view of a crushing head included in the seed sampling device of FIG. 2.

FIG. 6 is a top view of a collection plate disposed in the seed sampling device of FIG. 2.

FIG. 7 is a cross-sectional view of the collection plate of FIG. 6 taken along the line 7-7.

FIGS. 8A-8B are side-views of the seed sampling device of FIG. 2 in a first and a second configuration, respectively.

### DETAILED DESCRIPTION

Devices, systems and methods for crushing and extracting a portion of a seed are disclosed herein. In some embodiments, a seed sampling device can include a crushing head having a plurality of pins and a plate having a plurality of receptacles configured to receive and contain one or more seeds therein. The receptacles each include an aperture configured to receive at least a portion of the pins of the crushing head. The seed sampling device further includes a press operably coupled to the crushing head and configured to move the crushing head between a first configuration such that the plurality of pins are outside of the plurality of receptacles, and a second configuration such that the plurality of pins are disposed in the apertures of the plurality of receptacles. The movement from the first configuration to the second configuration is operative to sufficiently crush the individual seeds disposed in each of the receptacles such that a portion of the crushed seeds can be communicated through the aperture and out of the plate.

In some embodiments, a seed sampling device includes a crushing head having a plurality of pins, a plate having a plurality of receptacles configured to receive and contain individual seeds, and a press operably coupled to the crushing head and configured to sufficiently crush the individual seeds disposed in each of the receptacles such that a portion of the crushed seed can be communicated through an aperture in the receptacle and out of the plate.

The plurality of pins coupled to the crushing head can include a first portion having a first diameter and a second portion having a second diameter, the first diameter being greater than the second diameter. The second diameter can be smaller than the diameter of the apertures in the receptacles and the first diameter can be larger than the apertures such that only the second portion of the pins can fit into the apertures. Said another way, the pins and/or receptacles can be sized and/or shaped such that only a portion of the pins can fit into the apertures.

The receptacles and apertures can have any shape and/or cross section. For example, the receptacles can be substantially cylindrical, conical, or frusto-conical. The receptacles can have a base and the aperture can be disposed in the base of the receptacle. The base can be flat, tapered, rounded, etc. The apertures and/or pins can be configured to allow at least about 10%, about 20%, about 30%, or about 40%, or more of the total crushed seed mass to pass through the aperture and out of the plate/receptacles and into a plurality of wells and/or a collection plate.

The press can be any mechanical, electromechanical, or hydraulic mechanism configured to transfer a sufficient force to the seeds via the crushing head to crush the seeds. For example, the press can be a hydraulic actuator or a stepper motor. The press can be configured to exert at least about 1,500-2,000 psi to the seeds.

As used herein, the term “about” means +/−10% of the total amount stated, e.g. about 5 would include 4.5 to 5.5, about 10 would include 9 to 11, about 100 would include 90 to 110.

As used herein, the terms “extract”, “sample” and “punch”, mean removing a tissue portion from an intact seed using the seed sampling device.

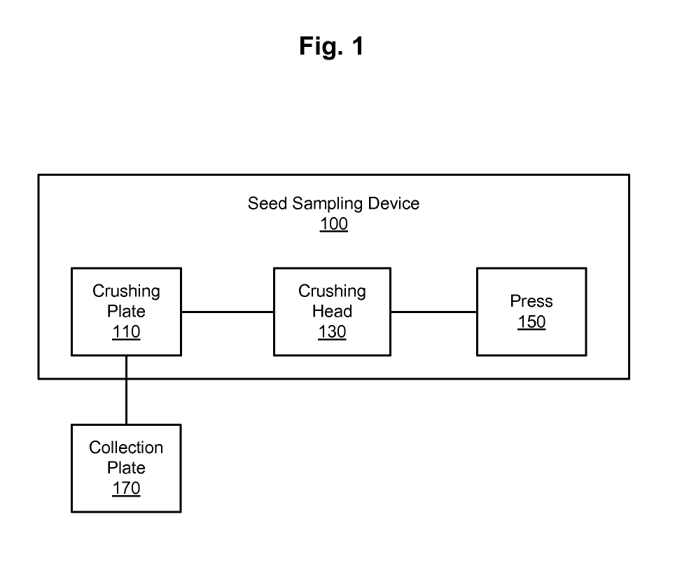

FIG. 1 is a schematic block diagram of a seed sampling device 100 that can be used for extracting seed samples from whole seeds. The seed sampling device 100 includes a crushing plate 110, a crushing head 130, and a press 150. The crushing plate 110 is configured to removably receive at least a portion of the crushing head 130. A collection plate 170 can be disposed in the seed sampling device 100 to collect seed samples extracted by the seed sampling device 100. As used herein, the term seed can include whole seeds collected from any plant including, but not limited to maize, rice, wheat, barley, soy, cotton, jatropha, sugar beet, castor, papaya, apples, oranges, pears, etc.

The crushing plate 110 includes a plurality of receptacles (not shown). Each of the plurality of receptacles is configured to receive one or more seeds. The crushing plate 110 can be formed from a strong, rigid, and wear resistant material such as, for example, steel, stainless steel, aluminum, titanium, tungsten, metal alloys, any other suitable material or a combination thereof. Each of the plurality of receptacles includes an aperture (not shown) at the base of each receptacle. The apertures can have a cross-section smaller than the cross-section of the distal end of the receptacle such that only a portion of the seed that is crushed in the seed sampling device 100 is transferred out of the crushing plate 110, for example, by the crushing head 130 as described further below. In some embodiments, the receptacles can be arranged in a substantially rectangular array, for example, an 8×12 array or a 16×24 array, such that there are a total of 96 or 384 receptacles in the crushing plate, respectively. In some embodiments, the receptacles can be arranged in any other suitable configuration. In some embodiments, the center to center spacing between each receptacle on the crushing plate can be about 0.6 inches. In other embodiments, the center to center spacing can be less or greater depending on any of a number of factors including, for example, the size of the seeds being sampled.

In some embodiments, each of the plurality of receptacles can be sized and shaped to receive a particular seed sample, for example, maize. In some embodiments, the receptacle is substantially cylindrical. In some embodiments, the receptacle can have a square, oval, or polygonal cross-section. In some embodiments, each of the plurality of receptacles can have a diameter of 1/16 inch, ⅛ inch, ¼ inch, ½ inch, ⅔ inch, ¾ inch, or any other suitable diameter. In some embodiments, the base of the receptacles is substantially flat, with the aperture located substantially at the center of the base. In some embodiments, the receptacles can be frusto conical such that the tapered portion of the frusto cone leads to the edge of the aperture that is located at the base of the receptacle. In some embodiments, the base of the receptacles can be tapered, rounded, filleted or chamfered. Such features can, for example, prevent compacting of the seed at the base of the receptacles and can ensure that an appropriate amount of the crushed seed is forced through the aperture and out of the plate 110.

In some embodiments, each of the plurality of receptacles can include a single aperture at the base of the receptacle. In some embodiments, a plurality of apertures can be located at the base of each of the plurality of receptacles such that each aperture defines a lumen. In some embodiments, the apertures can be flared or tapered such that, a cross section of the apertures at the end proximal to the receptacles is smaller than cross-section of the apertures at the end distal to the receptacles, for example, to prevent the extracted portion of the seed from getting stuck in the lumen defined by the aperture. In some embodiments, the apertures can be sized and shaped to allow only a portion of a seed to pass through, for example, when a crushing force is applied by the crushing head 130 as described in further detail below. For example, the apertures can be sized and shaped to allow about 10%, about 20%, about 30%, about 40%, or more of the total seed mass to pass through the aperture and out of the plate/receptacles and into a plurality of wells and/or a collection plate 170. In some embodiments, the edge the aperture at the base of each of the plurality of receptacles can have features configured to create a sharp edge, for example, to allow easy extraction of sample from a seed. In some embodiments, the apertures can be configured to include a valve such that, for example, a pivotable metal plate, septum, or any other one way valve that allows a portion of the seed to pass in only one direction from the crushing plate 110 to the collection plate 170. In some embodiments, the receptacles can also include a mechanism to supply compressed air to the apertures such as, for example, openings, nozzles, valves, fluidic channels, etc., to clean the apertures of any seed debris. In some embodiments, the plurality of receptacles and apertures of the crushing plate 110 can be cleaned with compressed air applied at a pressure of about 30 psi to avoid cross-contamination. In some embodiments, the plurality of receptacles and apertures of the crushing plate 110 can be washed, rinsed, and/or sterilized after use to avoid cross-contamination.

In some embodiments, the crushing head 130 includes a substantially flat plate and a plurality of pins coupled to the plate (not shown). In some embodiments, the plate and pins of the crushing head 130 can be formed in single manufacturing process, for example, a casting, milling, turning, forging, stamping or any other suitable process, such that the pins are a permanent part of the base. In some embodiments, the pins can be manufactured separately and then fixedly or removably coupled to the base, for example, by welding, riveting, bolting screwing, gluing, clamping, snap-fit mechanism or through any other suitable coupling mechanism. The crushing plate 110 can have alignment features, for example, to receive the crushing head 130 in a preferred alignment and orientation with high tolerance. In some embodiments, the crushing plate 110 can be formed from a light weight but rigid material, e.g., aluminum, steel, stainless steel, wood, plastic, any other suitable material or combination thereof. In some embodiments, the pins can be formed from a strong rigid and wear resistant material, e.g. steel, stainless steel, hardened steel, titanium, tungsten, metal alloys, or any other combination thereof.

The plurality of pins can be arranged in an array, configured to align and mate with the receptacle array of the crushing plate 110 such that each receptacle receives a single pin of the crushing head 130. The plurality of pins can be sized and shaped to mate with the receptacles and/or with the apertures of the crushing plate 110. The plurality of pins can be further configured to crush and discharge a portion of the seed disposed in each of the plurality of receptacles when the crushing head 130 is mated with the crushing plate 110. In some embodiments, the pins can be substantially cylindrical and can protrude into the lumen of the aperture. In some embodiments, the cross-section of the pins can be in close tolerance with the cross-section of the apertures. In some embodiments, the cross-section of the pins can be substantially smaller than the apertures of the crushing plate 110. In some embodiments, each of the plurality of pins can be configured to have a first section and a second section. The first section can be configured to have a cross-section substantially greater than the cross-section of the aperture, and the second section can have a cross-section slightly/substantially smaller than the apertures, such that when the crushing head 130 mates with the crushing plate 110, only the second section protrudes into the apertures, while the first section remains in the receptacles. In some embodiments, the second section of each of the plurality of pins can have a diameter of 1/16 inch, ⅛ inch, ¼ inch, 5/32 inch, 3/16 inch, or any other suitable diameter based on the size of the portion of the seeds that needs to be extracted. In some embodiments, a transition region where the first section is connected to the second section has a 90 degree profile. In some embodiments, the transition region can be chamfered, filleted, contoured, rounded, etc.

In some embodiments, an end of each of the plurality of the pins that is configured to protrude into the apertures can be substantially flat (e.g., 90 degree profile). In some embodiments, the end can be tapered, filleted, chamfered, rounded, contoured such that, for example, the pins can protrude into the apertures even if there is a slight mismatch in the alignment of the plurality of pins of the crushing head 130 with the plurality of apertures of the crushing plate 130. In some embodiments, the end can have features such as, for example, grooves, abrasions, pits, sharp edges, and/or any other features, to facilitate crushing and/or extraction of a portion of the seed from the whole seed. In some embodiments, the pins can have a length such that the pins protrude only into a portion of the lumen of the crushing plate 130. In some embodiments, the pins can be configured to protrude through the lumen and into collection wells (not shown) of the collection plate 170, described below. Such a configuration can be beneficial, for example, to ensure that the extracted portion of the seed is completely discharged from the aperture/lumen. In some embodiments, the pins can have a useable punch length of about ½ inch. In some embodiments, the plurality of pins can be hollow and/or otherwise define a lumen through the pin. Such a configuration can be used to communicate gases, for example, compressed air, nitrogen, argon, helium, or any other gas through the pins, for example, to clean the receptacles/apertures.

The press 150 can be used to exert a force on the crushing head 130 to urge the crushing head 130 to mate with the crushing plate 110 and crush the seeds disposed in each of the plurality of receptacles of the crushing plate 110 and discharge a portion of the crushed seeds out of the crushing plate 110 via the apparatus to the collection plate 170. The press 150 can be any suitable actuator such as, for example, a hand press, a screw press, a gear press, a stepper motor, or a hydraulic press. In some embodiments, the press 150 can be configured to deliver a fixed pressure on the crushing head 130. For example, in some embodiments, the press 150 can be configured to deliver a pressure range in the range of 1,500-2,000 psi. In some embodiments, the pressure delivered by the press 150 can be adjusted, for example, to a maximum operating pressure of 2,000 psi. In some embodiments, the press 150 can be configured to deliver a pressure profile, for example, a pressure gradient (e.g., gradually increasing pressure), pressure cycles (e.g. low pressure, followed by high pressure, then low pressure and so on), hammering motion, etc. In some embodiments, the press can be configured to exert a first force on the crushing head 130 sufficient to crush the seeds and a second force, less that the first force, sufficient to discharge a portion of the crushed seeds out to of the crushing plate 110 and to the collection plate 170 via the apertures. In some embodiments, the press 150 can include pressure adjusting mechanisms, for example toggle switches to select the desired pressure profile and/or computer control. In some embodiments, the press 150 can also include pressure gauges, an over pressure switch (e.g., to end cycle if too high of a pressure is detected), and/or valves (e.g., to control the flow of hydraulic fluid). In some embodiments, the stroke of the press 150 can be adjusted by, for example, physically moving limit switches and/or by controlling the flow of hydraulic fluid.

The collection plate 170 can be removably disposed in the seed sampling device 100 and can be configured to receive a portion of the crushed seeds as described herein. The collection plate 170 can be formed from a light weight, rigid and inert material, for example, polytetrafluoroethylene, high density polyethylene, polycarbonate, acrylic, Delrin (polyoxymethylene), other plastics or light weight metals, e.g., aluminum. The collection plate 170 can be configured to include a plurality of wells (not shown) arranged in an array that aligns with the receptacle/aperture array on the crushing plate 110 when the collection plate 170 is disposed in the seed sampling device 100. In some embodiments, the collection plate 170 is custom made. In some embodiments, a commercially available 96 or 384 microwell plate can be used as the collection plate 170.

In some embodiments, the collection plate 170 can be configured to receive the extracted portion of the crushed seeds directly in the plurality of wells of the collection plate 170. In some embodiments, the collection plate 170 can be disposable or can be used after washing. In some embodiments, a container (not shown), for example, an eppendorf® tube, a 2 ml tube, a 15 ml tube, or a glass container can be removably disposed in each of the plurality of wells to receive and store the extracted portion of the seed. This can, for example, eliminate the need for washing the collection plate 170 and increase its useful life. In some embodiments, the height of the wells and/or container can be configured such that, for example, when the crushing head 130 is fully coupled with the crushing plate 110, a portion of the plurality of pins protrude into the wells or container. This can, for example, ensure that the extracted portion of each seed is received only by the appropriate container to prevent cross contamination. In some embodiments, the diameter of each of the plurality of wells can be ½ inch. In some embodiments, the container can have a smaller outer diameter than the diameter of the wells, for example, 5/16 inch, so that the containers can be easily disposed in the wells.

In some embodiments, the collection plate 170 can include alignment features, for example, pins, notches detents, grooves, have a trapezoidal shape, have selected edges chamfered or filleted, tabs, labels direction arrows, and/or markings to ensure that the collection plate 170 can be loaded only in a preferred orientation in the seed sampling device 100 and in alignment with the receptacle/aperture array on the crushing plate 110. In some embodiments, the collections plate 170 can be loaded and/or unloaded manually into the seed sampling device 100. In some embodiments, the seed sampling device 100 can include loading and alignment features, for example, stopper pins, guide rails, grooves, notches, detents, any other snap-fit mechanism, and/or any other alignment feature configured to facilitate loading of the collection plate 170 and alignment with the crushing plate. In some embodiments, the seed sampling device 100 can include automatic loading capabilities, for example, conveyor belts, X-Y motors, pneumatic lifters, and/or any other positioning means for loading and unloading the collection plate 170 from the seed sampling device 100. In some embodiments, the seed sampling device 100 can include machine vision to ensure alignment.

In some embodiments, the seed sampling device 100 can also include a control system (not shown) for controlling the press 150, and/or loading and unloading of the collection plate 170. The control system can include, for example, a programmable logic controller (e.g. DL05, PLC, Automation Direct), push buttons for starting and stopping press cycles, an emergency stop switch, a hydraulic motor starter, a communication interface to notify an operator of system status and/or for the operator to enter commands (e.g., press 150 settings). In some embodiments, the seed sampling device 100 can also include a safety switch (not shown) to turn off the device 100 if, for example, the collection plate 170 is prematurely removed from the device 100, or if a door (not shown) of the device 100 is opened.

Having described above various general principles, several exemplary embodiments of these concepts are now described. These embodiments are only examples, and many other configurations of a seed sampling device, and/or systems for extracting tissue portions from a batch of whole seed samples simultaneously, are contemplated.

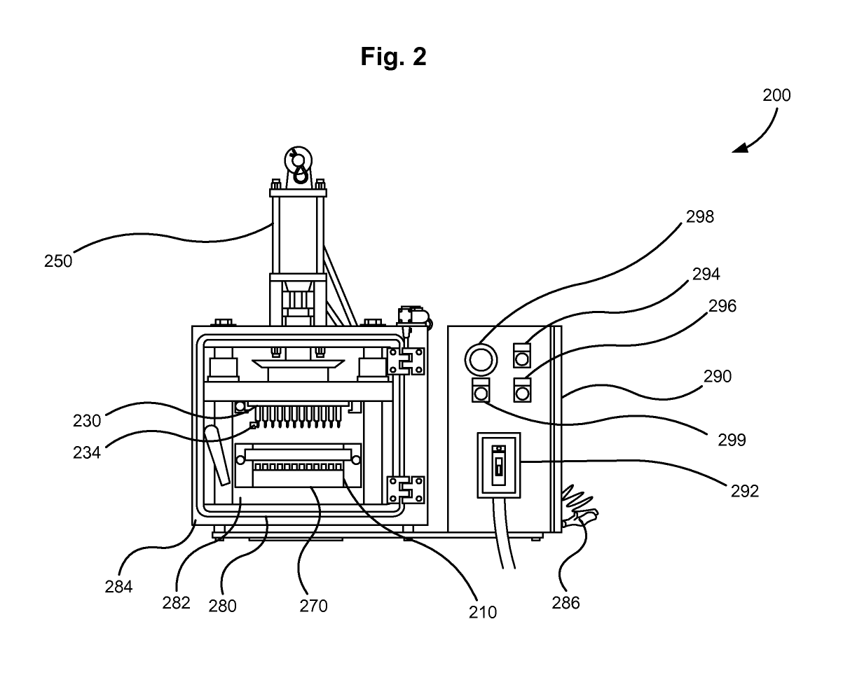

Referring now to FIG. 2, a seed sampling device 200 can include a crushing plate 210, a crushing head 230 and a hydraulic actuator 250. The crushing plate 210 includes a plurality of receptacles 212 sized and shaped to receive a single whole seed. In some embodiments, the receptacles 212 can be sized and shaped to receive one to four seeds. Each of the plurality of receptacles 212 includes an aperture (not shown) disposed at the base configured to allow only of a portion of the crushed seed to pass through when the crushing plate 210 mates with the crushing head 230 and crushes the seeds. The crushing head 230 includes a plurality of pins 234 coupled to a plate (not shown) in an array. The array of pins 234 is configured to align with the array of receptacles 212 in the crushing plate 210. The pins 234 are configured to protrude into the receptacles 212 and apertures of the crushing plate 210, such that a portion of the seed disposed in the each of the plurality of receptacles can be discharged through the apertures. The seed sampling device 200 can be configured to removably receive a collection plate 270 for receiving an extracted portion of a crushed seed. The crushing plate 210, the crushing head 230 and the plate 270 are described in further detail below.

The hydraulic actuator 250 is configured to exert a force on the crushing head 230 to urge the crushing head 230 to move towards and mate with the crushing plate 210. The hydraulic actuator is further configured to apply a sufficient force such that, the seeds disposed therein are crushed and a portion of the crushed seeds are discharged out of the crushing plate through the apertures. In some embodiments, the hydraulic actuator 250 can include, for example, a hydraulic motor (not shown), e.g., 2 hp 220V AC, and a hydraulic cylinder 252, e.g., a 4 inch bore×6 inch stroke. The hydraulic motor can be configured to deliver a pressurized hydraulic fluid to the hydraulic cylinder such that the hydraulic cylinder presses on and urges the plurality of pins 234 of the crushing head 230 towards the crushing plate 210 and into the receptacles 212 of the crushing plate 210. In some embodiments, the hydraulic actuator 250 can be configured to deliver a fixed or variable pressure on the crushing head 230. For example, the hydraulic motor can be configured to deliver 1.5 gallons of hydraulic fluid per minute to the hydraulic cylinder 252 at a pressure range, for example, of 1,500-2,000 psi. In some embodiments, the pressure delivered by hydraulic actuator 250 can be adjusted, for example, to a maximum operating pressure of 2,000 psi. In some embodiments, the hydraulic actuator 250 can be configured to deliver a pressure profile, for example, a pressure gradient (e.g., gradually increasing pressure), pressure cycles (e.g., low pressure followed by high pressure, then low pressure, so on), hammering motion, etc. In some embodiments, the hydraulic actuator 250 can include pressure gauges, over pressure switches (e.g., to stop press if too high a pressure is detected), and/or valves (e.g., to control the flow of hydraulic fluid). In some embodiments, the stroke of the hydraulic actuator 250 can also be adjusted, for example, by physically moving limit switches and/or by controlling the flow of hydraulic fluid.

The seed sampling device 200 can include a housing 280 that can define an interior region 282 sized and shaped to house the crushing plate 210, the crushing head 230 and the collection plate 270. The housing can be made from a strong and rigid material, for example, steel, stainless steel, aluminum, polycarbonate, acrylic, any other suitable material or a combination thereof. At least a portion of the housing can be transparent, for example, to allow viewing of the interior region 282 of the housing 280 of the seed sampling device 200 during operation.

Each of the crushing plate 210, crushing head 230 and the collection plate 270 can be removably disposed in the interior region 282 of the housing. In some embodiments, the housing 280 can include alignments features such as alignment pins, guide rails, grooves, notches, jigs, fixtures, and/or any other suitable features or combination thereof, to ensure that the crushing plate 210, crushing head 230 and the collection plate 270 are aligned with each other during operation. In some embodiments, the housing 280, can also include a door 284 that can be closed during operation of the seed sampling device 200, for example, for safety reasons. The door can be substantially transparent, for example, to allow an operator to view the interior region 282 of the housing 280 during operation to identify and address any errors. In some embodiments, the door 284 can include a safety switch such that, the device is shut down when the door is opened.

In some embodiments, the collection plate 270 can be manually loaded into the housing 280 of the seed sampling device 200. In some embodiments, the housing can include mechanisms for automatic loading and unloading the collection plate 270 such as, for example, conveyor belts, positionable trays, stepper motors, pneumatic/hydraulic lifter, etc. In some embodiments, the seed sampling device 200 can also include a compressed air system 286 that can include, for example, a tube, a hose, a nozzle, a compressed air cylinder, safety valves, etc. In some embodiments, the compressed air system 286 can be used to supply pressurized air or any other inert gas, for example, at a pressure of 30 psi that can be used for cleaning the crushing plate 210 and/or crushing head 230 from any seed residue. In some embodiments, the compressed air system 286 is used to supply air directly into air supply features, for example, nozzles provided in the apertures of the crushing plate 210 and/or to a lumen defined in each of the plurality of pins 234 of the crushing plate 230.

The control system 290 can be used to control the operation of the seed sampling device 200. In some embodiments, the control system 290 can include a power switch 292. The power switch can be a toggle switch to power on/off the seed sampling device 200. In some embodiments, the control system 290 can include a start button 294 and a stop button 296 that can be used to start and stop the seed sampling device 200 and/or a seed sampling cycle. In some embodiments, the control system 290 can include a motor on/off button 298 that can be used to switch the hydraulic motor and/or the hydraulic actuator 250 on or off. In some embodiments, the control system 290 can also include an emergency stop button 299, for example, to stop the device in the middle of a cycle in case of an error or emergency.

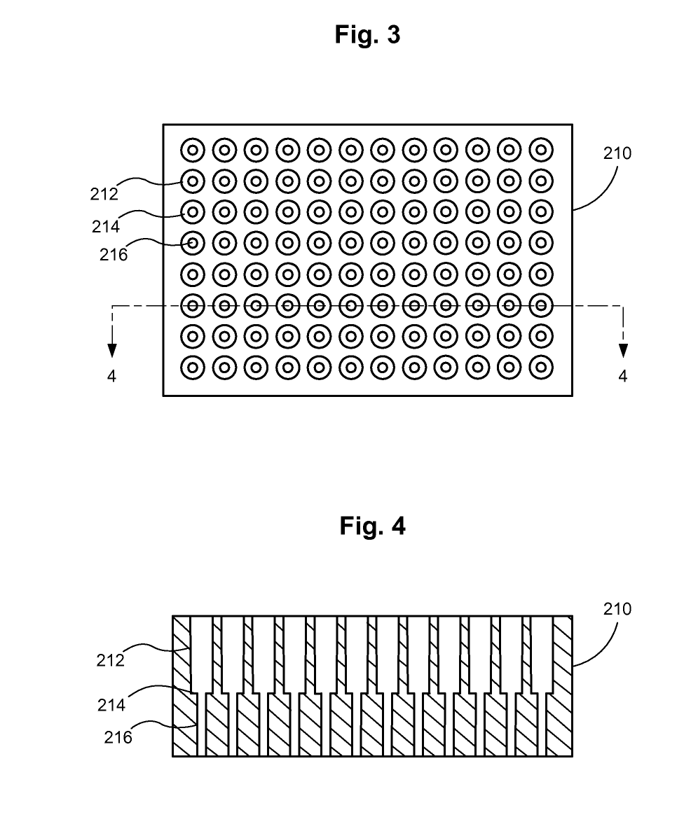

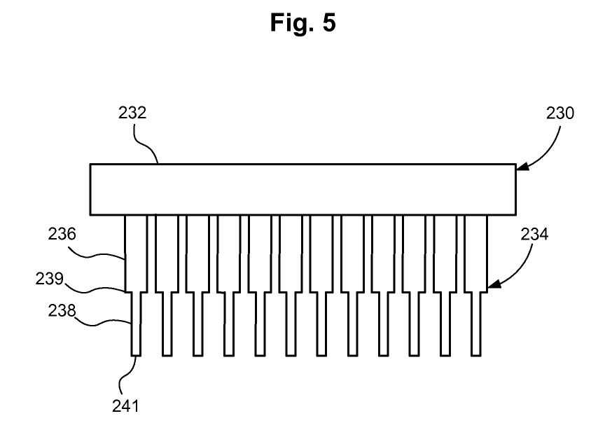

Referring now to FIG. 3 and FIG. 4, the crushing plate 210 is shown according to an embodiment. As described herein, the crushing plate 210 includes a plurality of receptacles 212 having an aperture 216 at a base 214 of each of the plurality of receptacles 212. The crushing plate 210 can be formed from a strong, rigid and wear resistant material, for example, steel, stainless steel, titanium, tungsten, metal alloys, any other suitable material or combination thereof, using standard manufacturing processes, e.g. casting, milling, turning, forging, drilling, stamping, etc. In some embodiments, each of the plurality of receptacles 212 can be sized and shape so that a single seed can be disposed into each receptacle 212. In some embodiments, the size of each of the plurality of receptacles 212 can be adjusted to accommodate seeds of different sizes. For example, each receptacle 212 can have a diameter of 1/16 inch, ⅛ inch, ¼ inch, ½ inch, ⅔ inch, ¾ inch, or any other suitable diameter. As described herein, each of the plurality of receptacles 212 can have a cylindrical shape. In some embodiments, the receptacles 212 can be square, rectangular, oval, or polygonal.

In some embodiments the base 214 of each of the plurality of receptacles 212 is substantially flat with the aperture 216 located substantially at the center of the base 214. In some embodiments, the base 214 can be angular, tapered, rounded, chamfered, and/or filleted. In some embodiments, each of the plurality of receptacles 212 can be frusto conical in shape with the cone leading to the edge of the aperture 216. Such configurations can, for example, prevent the seed from being compacted at the base 214 of the receptacle 212. In some embodiments, the receptacles 212 can be arranged in an 8×12 array for a total of 96 receptacles. In some embodiments, depending on the size and shape of the seed, other configurations, e.g., a 16×24 array for a total of 384 receptacles, or other combinations can also be used. In some embodiments, the center to center spacing of each receptacle 212 can be ⅛ inch, ¼ inch, ½ inch, ⅝ inch, ⅔ inch, ¾ inch, or any other suitable spacing.

In some embodiments, each aperture 216 can define a lumen that is substantially cylindrical. In some embodiments, the apertures 216 can have a square, rectangular, oval, and/or polygonal cross-section. In some embodiments, the apertures 216 can be flared, or tapered such that a diameter of the apertures 216 at a location proximal to the receptacles 212 is smaller than the diameter of the apertures 216 at a location distal to the receptacles 212, for example, to facilitate easy passage of the extracted portion of the seed through the lumen of the aperture 216. In some embodiments, the apertures 216 can be sized and shaped to allow only a portion of the whole seed disposed in the receptacle 212 to pass through, for example, when a crushing force is applied on the seeds by the crushing head 230 as described later. In some embodiments, the apertures can be sized and shaped to allow about 10%, about 20%, about 30%, about 40%, or more of the total mass of the seed to pass through. In some embodiments, the apertures 216 can include a valve, for example, a metal plate, a septum, or any other one-way valve to prevent the extracted portion of the seed from going back into the receptacle 212. In some embodiments, the apertures 216 can also include mechanisms for delivering compressed air to the lumen of the apertures, for example, nozzles, fluidic channels, valves, etc, such that the apertures 216 can be cleaned in situ.

Referring now to FIG. 5, the crushing head 230 can include a plurality of pins 234 disposed on or otherwise coupled to a substantially flat plate 232. The plurality of pins 234 can be arranged in an array, configured to align and mate with the receptacle 212 array of the crushing plate 210 as described herein. The plate 232 can be made from a light weight and rigid material, e.g., aluminum, wood, plastic, metal alloys, or any other suitable material or a combination thereof. The pins 234 can be made from a strong, rigid and wear resistant material, for example, steel, stainless steel, tungsten, titanium, hardened steel, metal alloys, or any combination thereof. In some embodiments, the pins 234 can be permanently affixed to the plate 232, for example, welded, riveted, bolted, and/or glued. In some embodiments, the pins 234 can be removably coupled to the base 232, for example, screwed, threaded, clamped, and/or snap-fit.

In some embodiments, the each of the plurality of pins 234 can have a first section 236 and a second section 238 such that, for example, the first section 236 has a cross-section substantially larger than the cross-section of the aperture 216 but smaller than the cross section of the receptacles 212 of the crushing plate 210, and the second section 238 that has a cross-section slightly smaller (e.g., in relatively close tolerance) or substantially smaller than the cross-section of the aperture 216. In such embodiments, the pins 234 are configured so that when the crushing head 230 mates with the crushing plate 210, the first section 236 of each of the plurality of pins protrudes into and remains in the receptacle 212 of the crushing plate 210, and the second section 238 protrudes into the apertures 216 of the crushing plate 210. In some embodiments, the first section 236 and the second section 238 can be shaped as a cylinder. In some embodiments the diameter of the second section can be 1/16 inch, ⅛ inch, ¼ inch, 5/32 inch, 3/16 inch, or any other suitable diameter based on the size of the portion of the seeds that needs to be extracted. In some embodiments, a transition region 239, where the first section 236 meets with the second section 238, can have a 90 degree profile. In some embodiments, the transition region 239 can be chamfered, filleted, rounded, contoured, and/or resemble a frusto cone. In some embodiments, the transition region 239 can be shaped to substantially match the shape of the base 214 of the receptacles 212 of the crushing plate 210.

In some embodiments, the second section 238 of the pins 234 can have a length such that when the crushing head 230 mates with the crushing plate 210, the second section 238 protrudes into but remain substantially within the lumen defined by the apertures 216. In some embodiment, the second section 238 can protrude through the lumen defined by the apertures 216, for example, to ensure that the extracted portion of the seed is completely discharged from the lumen defined by the apertures 216. In some embodiments, the second section 238 can be ½ inch long (usable punch length).

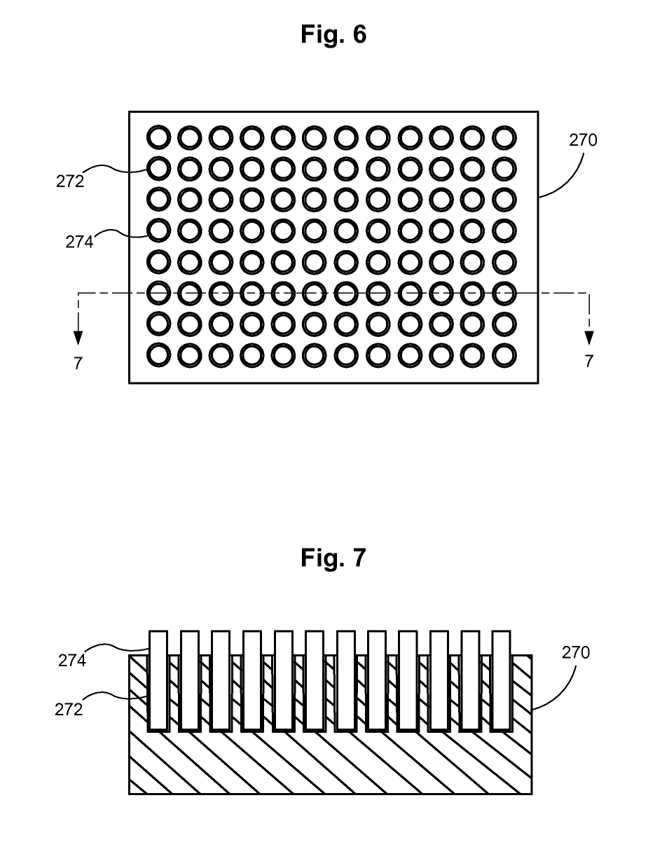

Referring now to FIG. 6 and FIG. 7, the collection plate 270 includes a plurality of wells 272 arranged in an array that aligns with the array of receptacle 212 on the crushing plate 210 when the collection plate 270 is disposed in the housing 280 of the seed sampling device 200. In some embodiments, the collection plate 270 can be configured to receive the extracted portion of the seeds directly in the plurality of wells 272 of the collection plate 270. In such embodiments, the collection plate 270 can be disposable or can be used after washing. As shown, the collection plate 270 can include a container 274, for example, an eppendorf® tube, a 2 ml tube, a 15 ml tube, a glass container, removably disposed in each of the plurality of wells 272 to receive and store the extracted portion of the seed. This can, for example, eliminate the need for washing the collection plate 270 and increase its useful life. In some embodiments, the diameter of each of the plurality of wells can be ½ inch. In some embodiments, the container can have a smaller outer diameter than the diameter of the wells, for example, ⅜ inch, so that the containers can be easily disposed in the wells. In some embodiments, the height of the wells and/or container can be configured such that, for example, when the crushing head 230 is fully coupled with the crushing plate 210, a portion of the plurality of pins 234 of the crushing head 230 protrudes into the wells 272 or containers 274. This can, for example, ensure that the extracted portion of each seed is received only by the appropriate container 274 to prevent cross contamination. In some embodiments, the collection plate 270 can further include alignment features, for example, pins, notches detents, have a trapezoidal shape, have selected edges chamfered or filleted, tabs, labels, direction arrows, and/or markings to ensure that the collection plate 270 can be loaded disposed only in a predetermined orientation in the seed sampling device 200 and in alignment with the receptacle 212 array on the crushing plate 210.

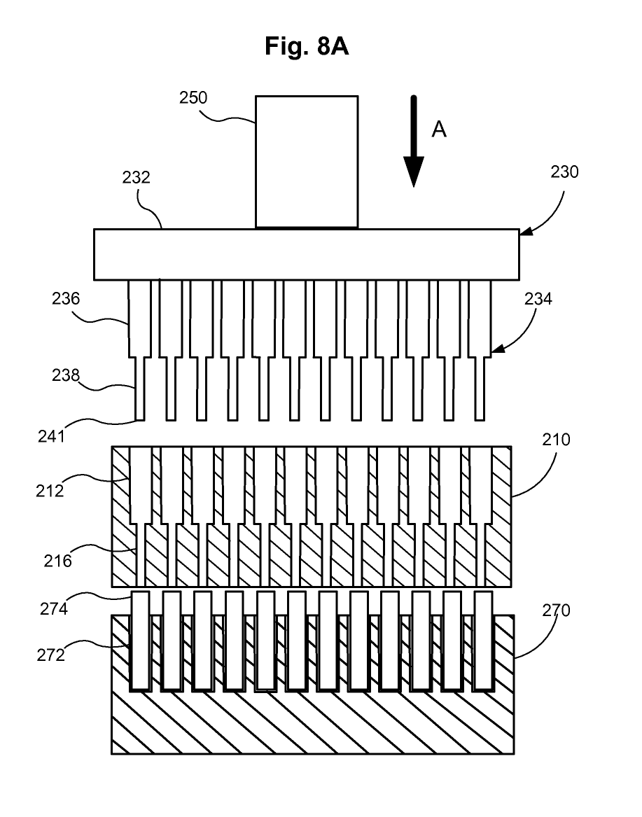

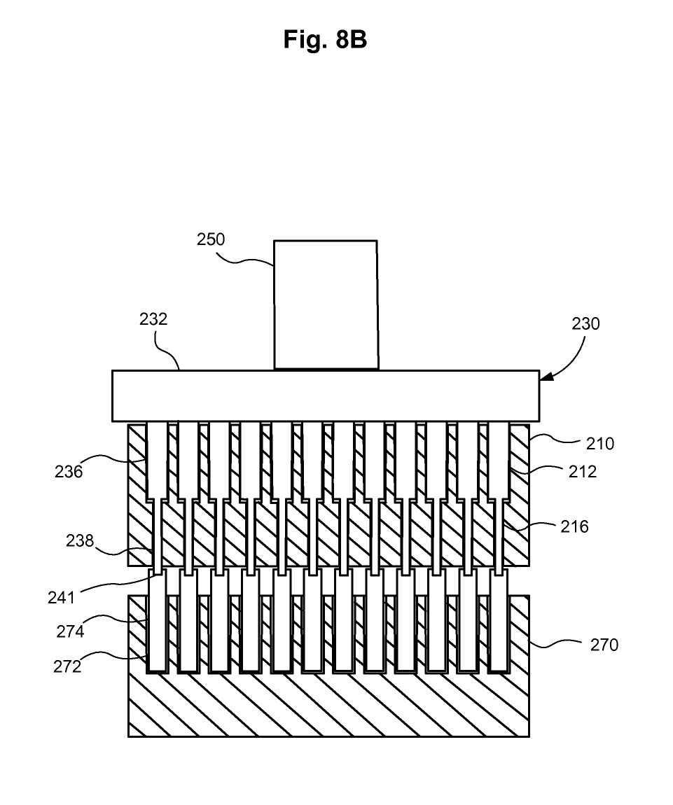

Referring now to FIGS. 8A and 8B, the seed sampling device 200 is shown in a first configuration (FIG. 8A) and a second configuration (FIG. 8B). In the first configuration, the crushing plate 210, the crushing head 230, and the collection plate 270 are positioned such that the each of the plurality of pins 234 of the crushing head 230 are aligned with the receptacles 212 of the crushing plate 210 and the wells 272 of the collection plate 270. A single whole seed (not shown) is disposed in each receptacle 212 of the crushing plate 210. In some embodiments, an operator can start the seed sampling cycle by turning on the hydraulic actuator 250. The hydraulic actuator 250 applies pressure on the crushing head 230 and urges the crushing head 230 in a direction indicated by arrow A in FIG. 8A. The displacement of the crushing plate 230 is defined by the stroke of the hydraulic actuator 250. The displacement of the crushing head 230 urges the plurality of the pins 234 of the crushing head 230 into each of the plurality of receptacles 212 of the crushing plate 210 such that, the end 241 of the second section 238 of the pins applies pressure on and crushes the seeds disposed in the receptacles 212. As the crushing head 230 advances, the pins further and protrude into the lumen defined by the apertures 216, such that a predetermined portion of the seed is discharged from the crushing plate 210 and into the collection plate 270. In some embodiments, the hydraulic actuator 250 can retract the crushing plate 230 back to the first configuration as shown in FIG. 8A. In some embodiments, the crushing head 230 can be spring mounted such that, for example, the springs urge the crushing head 230 to return to the first configuration when the hydraulic actuator 250 is turned off. At the end of the cycle, the collection plate 270 can be unloaded from the seed sampling device 200, and the containers 274 containing the seed samples can be removed for analysis.

While various embodiments of the invention have been described above, it should be understood that they have been presented by way of example only, and not limitation. Where methods and steps described above indicated certain events occurring in certain order, those of ordinary skill in the art having the benefit of this disclosure would recognize that the ordering of certain steps may be modified and that such modifications are in accordance with the variations of this invention. Additionally, certain of the steps may be performed concurrently in a parallel process when possible, as well as performed sequentially, as described above. The embodiments have been particularly shown and described, but it will be understood that various changes in form and details may be made.

For example, although various embodiments have been described as having particular features and/or combinations of components, other embodiments are possible having any combination or sub-combination of any features and/or components from any of the components described herein. For example, although some embodiments were described as having the hydraulic actuator apply a force on and urge the crushing head into the crushing plate, it should be understood, that the hydraulic actuator can in some embodiments, the force can be applied on the crushing plate. In addition, the specific configurations of the various components can also be varied. For example, the size and specific shape of the various components can be different than the embodiments shown, while still providing the functions as described herein.

1. A seed sampling device, comprising:
a crushing head having a plurality of pins;
a plate having a plurality of receptacles configured to receive and contain at least one seed therein, each of the plurality of receptacles including an aperture configured to receive at least a portion of a pin of the plurality of pins; and
a press operably coupled to the crushing head and configured to move the crushing head between a first configuration such that the plurality of pins are outside of the plurality of receptacles, and a second configuration such that the plurality of pins are disposed in the apertures of the plurality of receptacles, the movement from the first configuration to the second configuration operative to sufficiently crush the at least one seed disposed in each of the receptacles such that a portion of the crushed seed can be communicated through the aperture and out of the plate.

2. The device of claim 1, wherein each of the plurality of pins include a first portion having a first diameter and a second portion having a second diameter, the first diameter being greater than the second diameter.

3. The device of claim 2, wherein the plurality of receptacles are configured to receive the first portion of the plurality of pins and the apertures are configured to receive at least a portion of the second portion of the plurality of pins.

4. The device of claim 2, wherein the apertures have a diameter greater than the second diameter of the pins.

5. The device of claim 2, wherein the apertures have a diameter less than the first diameter of the pins.

6. The device of claim 1, wherein the apertures are configured to allow at least 10% of the crushed seed is communicated through the aperture and out of the plate.

7. The device of claim 6, wherein the apertures are configured to allow at least 20% of the crushed seed is communicated through the aperture and out of the plate.

8. The device of claim 7, wherein the apertures are configured to allow at least 30% of the crushed seed is communicated through the aperture and out of the plate.

9. The device of claim 8, wherein the apertures are configured to allow at least 40% of the crushed seed is communicated through the aperture and out of the plate.

10. The device of claim 1, wherein the apertures are configured to communicate the crushed seed material to a collection plate.

11. The device of claim 10, wherein the collection plate includes a plurality of wells, each of the plurality of wells corresponding to one of the plurality of receptacles.

12. The device of claim 1, wherein the plurality of receptacles are configured such that individual seeds are separated from each other before and after being crushed.

13. The device of claim 1, wherein each of the plurality of receptacles includes a base and the apertures are disposed at the base of the receptacles.

14. The device of claim 13, wherein the base is substantially flat.

15. The device of claim 13, wherein the base is conical.

16. The device of claim 1, wherein the press is a hydraulic actuator.

17. The device of claim 1, wherein the press is a mechanical press.

18. The device of claim 1, wherein the press is configured to exert a pressure on the seeds of at least about 1,500 psi.

19. The device of claim 1, wherein the press is configured to exert a pressure on the seeds in the range of about 1,500-2,000 psi.

20. A seed sampling device, comprising:
a crushing head having a plurality of pins, each of the plurality of pins including a first portion and a second portion, the first portion being larger than the second portion;
a plate having a plurality of receptacles configured to receive and contain an individual seed therein, each of the plurality of receptacles including an aperture configured to receive the second portion of the plurality of pins; and
a press operably coupled to the crushing head and configured to move the crushing head between a first configuration such that the plurality of pins are outside of the plurality of receptacles, and a second configuration such that the second portion of the plurality of pins are disposed in the apertures of the plurality of receptacles, the movement from the first configuration to the second configuration operative to sufficiently crush the individual seeds disposed in each of the receptacles such that a portion of the crushed seed can be communicated through the aperture and out of the plate.

21. The device of claim 20, wherein each of the plurality of pins are substantially cylindrical.

22. The device of claim 20, wherein each of the plurality of receptacles are substantially cylindrical.

23. The device of claim 20, wherein the aperture is configured to allow at least 10% of the crushed seed is communicated through the aperture and out of the plate.

24. The device of claim 23, wherein the aperture is configured to allow at least 20% of the crushed seed is communicated through the aperture and out of the plate.

25. The device of claim 24, wherein the aperture is configured to allow at least 30% of the crushed seed is communicated through the aperture and out of the plate.

26. The device of claim 25, wherein the aperture is configured to allow at least 40% of the crushed seed is communicated through the aperture and out of the plate.

27. The device of claim 20, wherein each of the plurality of receptacles includes a base and the apertures are disposed at the base of the receptacles.

28. The device of claim 27, wherein the base is substantially flat.

29. The device of claim 28, wherein the base is tapered.

30. The device of claim 20, wherein the press is a hydraulic actuator.

31. The device of claim 20, wherein the press is a mechanical press.

32. A method of collecting samples of seeds with a device having a plurality of receptacles, each of the plurality of receptacles configured to receive and contain an individual seed therein, each of the plurality of receptacles including an aperture configured to allow transferring of a portion of the seed out of the receptacles after the seed has been crushed, the method comprising:
disposing an individual seed in each of the plurality of receptacles;
moving a crushing head having a plurality of pins into the plurality of receptacles;
applying a force to the seeds with the crushing head thereby crushing the seeds;
transferring a portion of the crushed seeds through the apertures to a collection plate.

33. The method of claim 32, wherein the collection plate includes a plurality of wells, the method further comprising:
transferring the portion of the crushed seed from one receptacle to an individual well of the plurality of wells to prevent cross-contamination.

34. The method of claim 32, wherein the pressure applied is greater than about 1,500 psi.

35. The method of claim 32, wherein at least about 30% of the crushed seed is transferred to the collection plate.
